(19) United States
(12) Patent Application Publication
(10) Pub. No.: US 2011/0158660 A1
(43) Pub. Date: Jun. 30, 2011

(54) IMAGE FORMING APPARATUS

(75) Inventor: Akitoshi Suzuki, Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/974,167

(22) Filed: Dec. 21, 2010

Related U.S. Application Data
(60) Provisional application No. 61/290,424, filed on Dec. 28, 2009.

(51) Int. Cl. G03G 15/00; G03G 21/02

(52) U.S. Cl. 399/8; 399/21; 399/79

(57) ABSTRACT

Certain embodiments provide an image forming apparatus including: a transmission and reception part to receive print data of each of plural pages page by page. through a USB communication interface; a cassette part; a printing part; a paper discharge part; a manual paper feed tray on which the discharged sheet is set with the image being printed on a side of the sheet and an opposite side of the sheet being to be printed; and a control part that causes the printing part to print an even page on one side of a sheet from the cassette part and to print an odd page on the other side of the same sheet from the manual paper feed tray.

### CROSS-REFERENCE TO RELATED APPLICATION

The present application claims priority under 35 U.S.C. 119 to U.S. Provisional Application Ser. No. 61/290,424, entitled IMAGE FORMING APPARATUS, to SUZUKI, filed on Dec. 28, 2009, the entire disclosure of which is incorporated herein by reference.

### FIELD

Embodiments described herein relate generally to an image forming apparatus and a two-sided printing method of the image forming apparatus.

### BACKGROUND

In an image forming apparatus of an electrophotographic system, an image forming apparatus having no mechanism to reverse a sheet is known.

An image forming apparatus is also known in which the image forming apparatus and an external equipment are directly connected, and image data stored in the external equipment is subjected to two-sided printing by setting from the external equipment.

The image forming apparatus having no two-sided printing apparatus may be used in an environment in which LAN (local area network) is not configured.

When a computer equipment such as a personal computer causes the image forming apparatus to perform two-sided printing in the environment, the personal computer sends print data to the image forming apparatus through a USB (universal serial bus) cable.

The personal computer causes the image forming apparatus to print data of plural pages through the USB cable. The personal computer sets the first page of a document stored in the personal computer into the image forming apparatus. The image forming apparatus prints the first page on one side of a sheet.

After the sheet is discharged, the user reverses the printed sheet, and sets the sheet again in the cassette. The personal computer sets the second page of the document into the image forming apparatus. The image forming apparatus prints the second page on the back side of the sheet.

By repeating the series of procedures, the image forming apparatus realizes printing on both sides of the sheet.

However, the image forming apparatus is required to print pages one by one. It takes much labor and time for the user to perform two-sided printing by the image forming apparatus. There is a defect that two-sided printing by the image forming apparatus having no two-sided printing apparatus is inconvenient.

### BRIEF DESCRIPTION OF THE DRAWINGS

FIG. 1 is a view showing a connection relation between an image forming apparatus of an embodiment and a computer equipment;

FIG. 2 is a view showing an inner structure of the image forming apparatus of the embodiment;

FIG. 3 is a view showing a part of a hardware structure of the image forming apparatus of the embodiment;

FIGS. 4A to 4C are views showing an example of a software structure of the image forming apparatus of the embodiment;

FIG. 5 is a view showing a mutual relation among plural software modules of the image forming apparatus of the embodiment;

FIG. 6 is a view showing the basic sequence of a manual two-sided printing method;

FIGS. 7A to 7C are views for explaining the manual two-sided printing method of a document in which the number of pages is even;

FIG. 8 is a view showing an example of a display's indication of a computer equipment;

FIG. 9 is a view showing the print sequence of the manual two-sided printing method in which blank data is added;

FIGS. 10A to 10C are views for explaining the manual two-sided printing method of a document in which the number of pages is odd; and

FIGS. 11A to 11F are views for explaining the manual two-sided printing method of a document of plural pages having different page sizes.

### DETAILED DESCRIPTION

Certain embodiments provide an image forming apparatus including: a transmission and reception part configured to transmit and receive a command signal to and from a computer apparatus through a USB communication interface and receive print data of each of a plurality of pages page by page; a cassette part configured to feed a sheet on which the print data received by the transmission and reception part is to be printed; a printing part configured to form an image on the sheet and to output the sheet; a paper discharge part configured to store the sheet printed out by the printing part; a manual paper feed tray on which the sheet discharged from the paper discharge part is set with the image being printed on a side of the sheet and an opposite side of the sheet being to be printed; and a control part configured to cause the printing part to print an even page on one side of a sheet from the cassette part and print an odd page on the other side of the same sheet from the manual paper feed tray.

Hereinafter, an image forming apparatus and a two-sided printing method of the image forming apparatus will be described in detail with reference to the attached drawings. Incidentally, in the respective drawings, the same portion is denoted by the same reference numeral and its duplicate explanation is omitted.

The image forming apparatus of the embodiment is an MFP (multi function peripheral) having no two-sided printing apparatus.

The MFP is locally connected to a personal computer (computer apparatus) through a USB interface without using a LAN interface.

The MFP receives a print instruction and print data from the personal computer through the USB cable, and performs printing and outputting. The print data is a document divided page by page. One page includes a text, a line drawing, an image and the like.

The two-sided printing method of the embodiment is a method in which the MFP having no two-sided printing apparatus performs manual two-sided printing of the print data from the personal computer.

The manual two-sided printing is such that after the MFP prints one side of a sheet and outputs it, the user supplies the sheet to the MFP and printing is performed on the other side of the sheet. The user reverses a bundle of plural extracted sheets and sets them on a manual paper feed tray.

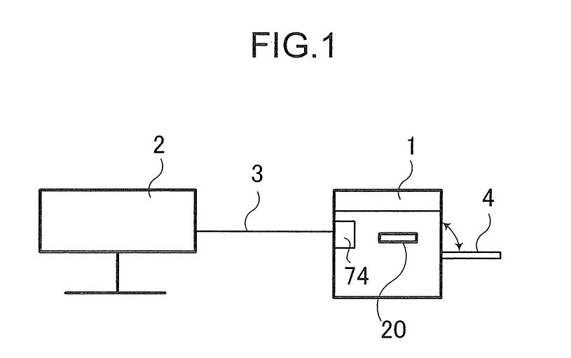

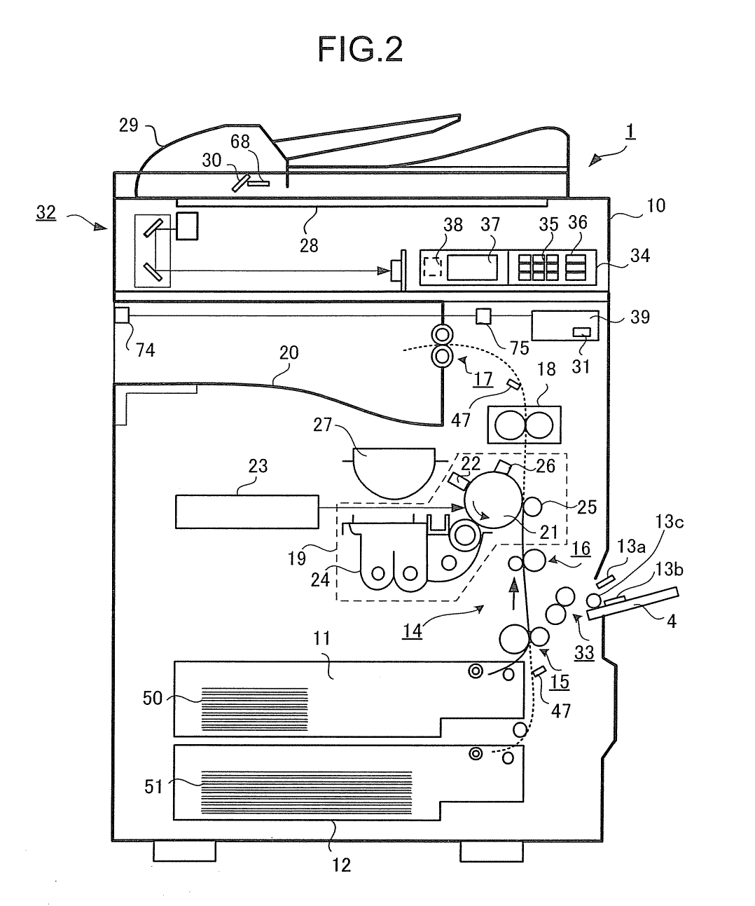

FIG. 1 is a view showing a connection relation between an MFP and a personal computer. FIG. 2 is a view showing an inner structure of the MFP. In the drawings, the same reference numeral denotes the same component.

An MFP 1 is connected to a personal computer 2 through a USB cable 3.

The MFP 1 includes cassette parts 11 and 12 at a lower part of a main body 10. The cassette part 11 contains a sheet 50. The cassette part 12 contains a sheet 51. The sheet size of the sheet 50 contained in the cassette part 11 is different from the sheet size of the sheet 51 contained in the cassette part 12.

The MFP 1 includes a conveyance mechanism 14 (printing part). The conveyance mechanism 14 conveys the sheet 150 to, for example, an upper part. The conveyance mechanism 14 includes roller pairs 15, 16 and 17 and a fixing unit 18.

The roller pair 15 is a pair of conveyance rollers. The roller pair 15 conveys the sheet 50 to an image forming process part 19 (printing part).

The roller pair 16 is a pair of register rollers. The roller pair 17 is a pair of paper discharge rollers. The roller pair 17 guides the printed sheet 50 to a paper discharge tray 20. A fixing unit 18 includes a heat roller and a press roller.

The MFP 1 includes the image forming process part 19 at the center in a height direction of the main body 10. The image forming process part 19 includes a photoconductive drum 21. The photoconductive drum 21 includes a drum and a photoreceptor.

The image forming process part 19 includes a charging unit 22, a laser scan unit 23, a developing unit 24, a transfer unit 25 and a cleaner 26 at a side of the outer circumference of the photoconductive drum 21. The image forming process unit 19 includes a toner supply device 27 above the developing unit 24.

The photoconductive drum 21 rotates in a counterclockwise direction. The charging unit 22 uniformly charges the photoconductive drum 21.

The laser scan unit 23 irradiates a laser beam to a position on the photoconductive drum 21 to be exposed. The laser scan unit 23 forms an electrostatic latent image on the photoconductive drum 21. The developing unit 24 develops the electrostatic latent image on the photoconductive drum 21.

The transfer unit 25 includes a transfer roller. The transfer unit 25 is charged. The transfer unit 25 transfers the toner image on the photoconductive drum 21 to the sheet 50. The cleaner 26 removes toner remaining on the photoconductive drum 21.

The MFP 1 includes a glass plate 28 at an upper part of the main body 10. The MFP 1 includes an automatic document feeder 29 on the glass plate 28.

The MFP 1 includes an image sensor unit 30 in the automatic document feeder 29. The image sensor unit 30 is a CIS (contact image sensor) unit.

The image sensor unit 30 is moved by a motor in a sub-scanning direction. An ADF (automatic document feeder) control board 68 drives the motor. The image sensor unit 30 reads an upper surface of a document and outputs a read signal to an image processing part 31.

The image processing part 31 creates image data having a pixel pattern of a set of bits.

The image processing part 31 converts signals outputted from the image sensor unit 30 and the scanner unit 32 into image data. The image processing part 31 stores the image data in a memory. The image processing part 31 is an LSI (large scale integration).

The MFP 1 includes the scanner unit 32 below the glass plate 28. The scanner unit 32 reads the lower surface of a document on the glass plate 28. The scanner unit 32 reads the lower surface of the document, and outputs a read signal to the image processing part 31.

The MFP 1 reads the document at two positions on the glass plate 28. The scanner unit 32 reads the image of the lower surface of the document at a first position.

The automatic document feeder 29 moves the document. The image sensor unit 30 reads the image of the upper surface of the document at a second position.

The laser scan unit 23 modulates laser light based on the image data. The photoconductive drum 21 forms an electrostatic latent image corresponding to an image to be copied on the photoconductive drum 21.

The developing unit 24 charges toner to the reverse polarity to the polarity of the electrostatic latent image. The developing unit 24 attaches the toner to the electrostatic latent image.

The conveyance mechanism 14 conveys the sheet 50 upward from the cassette part 11. The conveyance mechanism 14 aligns the leading end of the sheet 50 by the roller pair 16.

The image forming process part 19 applies a bias of reverse polarity to the polarity of toner to the sheet 50 by the transfer unit 25 from the back side of the sheet 50. The image forming process part 19 transfers the toner to the sheet 50 by electrostatic force.

The conveyance mechanism 14 conveys the sheet 50 to the fixing unit 18. The fixing unit 18 applies heat and pressure to the sheet 50. The fixing unit 18 fixes the toner image on the sheet 50 by the heat and pressure.

The conveyance mechanism 14 discharges the sheet 50 subjected to the image formation to the paper discharge tray 20. The conveyance mechanism 14 and the image forming process part 19, which are the printing part, form an image on one side of the sheet 50 and discharges the sheet 50.

The conveyance mechanism 14 includes plural jam sensors 47. The jam sensors 47 detect the occurrence of a jam and the removal of the jam. When the sheet 50 is caught in a conveyance path, the controller 39 stops printing.

The MFP 1 includes a manual paper feed tray 4 below the image forming process unit 19. The manual paper feed tray 4 is opened and closed at the side of the main body 10.

The MFP 1 includes a switch 13a, a sensor 13b and a roller pair 13c at the manual paper feed tray 4. The switch 13a is, for example, a micro switch. The switch 13a detects that the position of the manual paper feed tray 4 is open or close.

The sensor 13b detects that the sheet 50 is set. The sensor 13b uses contact or light shielding.

The roller pair 13c pulls in the sheet 50 by an instruction of the controller 39. The MFP 1 includes a roller pair 33. The roller pair 33 guides the sheet 50, which is supplied from the outside of the main body 10 to the paper feed tray 4, to the conveyance mechanism 14.

The MFP 1 includes an operation panel 34 at the upper part of the main body 10. The operation panel 34 includes plural keys 35, an LED (light emitting diode) 36, a display 37 and a panel board 38.

The display 37 is an LCD (liquid crystal display). The panel board 38 is a control board including a drive circuit.

The MFP 1 includes the controller 39. The control by the controller 39 includes main control, panel control, memory control, codec control, scanner control, printer control, and personal computer interface control between the personal computer 2 and the MFP 1.

The main control includes system control and job control. The codec control is control of data compression and expansion.

The MFP 1 and the personal computer 2 transmit and receive a command indicating manual two-sided printing. The command is a data signal of an AT command belonging to an AT command set (Hayes command set).

The MFP 1 and the personal computer 2 insert a parameter required for manual two-sided printing into the command. The parameter is a data signal added to the AT command.

When the MFP 1 is compared with the related art, the MFP 1 is different from the image forming apparatus of the related art in that the MFP inserts the parameter for manual two-sided printing into the command in compliance with the USB communication protocol.

When the related art image forming apparatus is instructed to print all pages on one side of sheets by the command under the USB communication protocol from the personal computer 2, the image forming apparatus prints all the pages on only one side of the sheets.

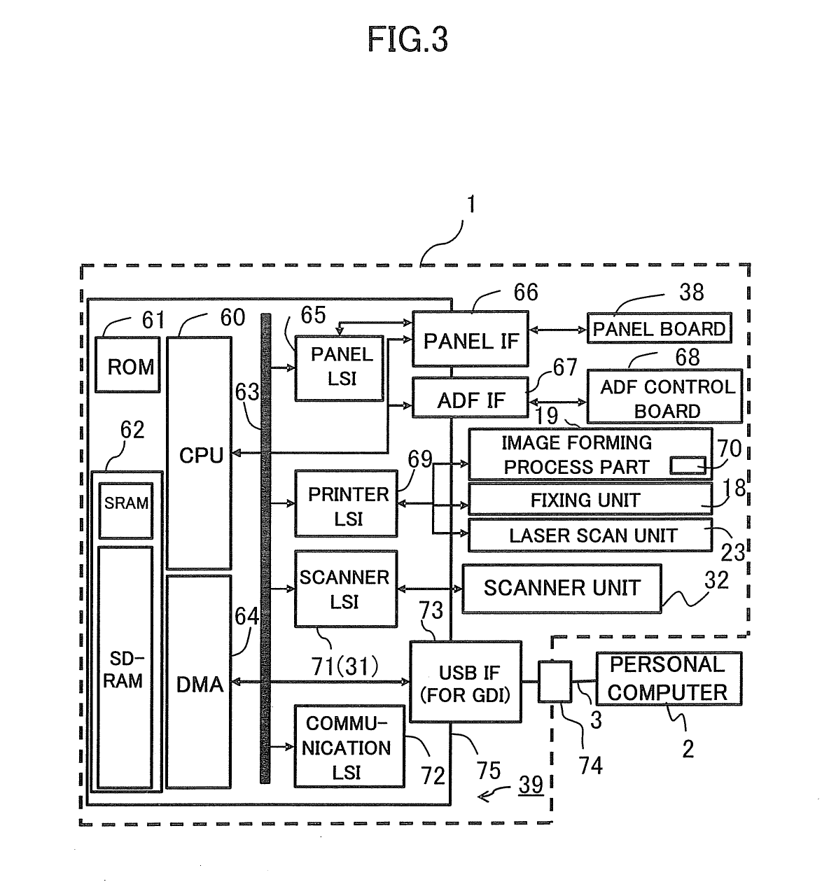

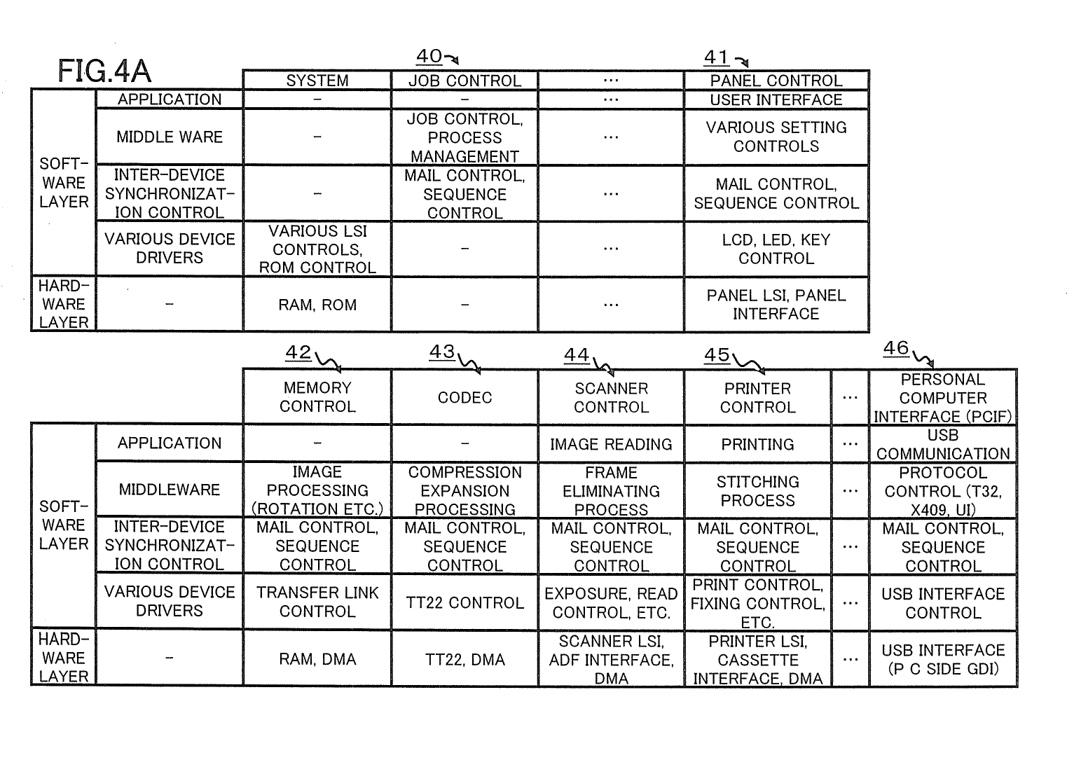

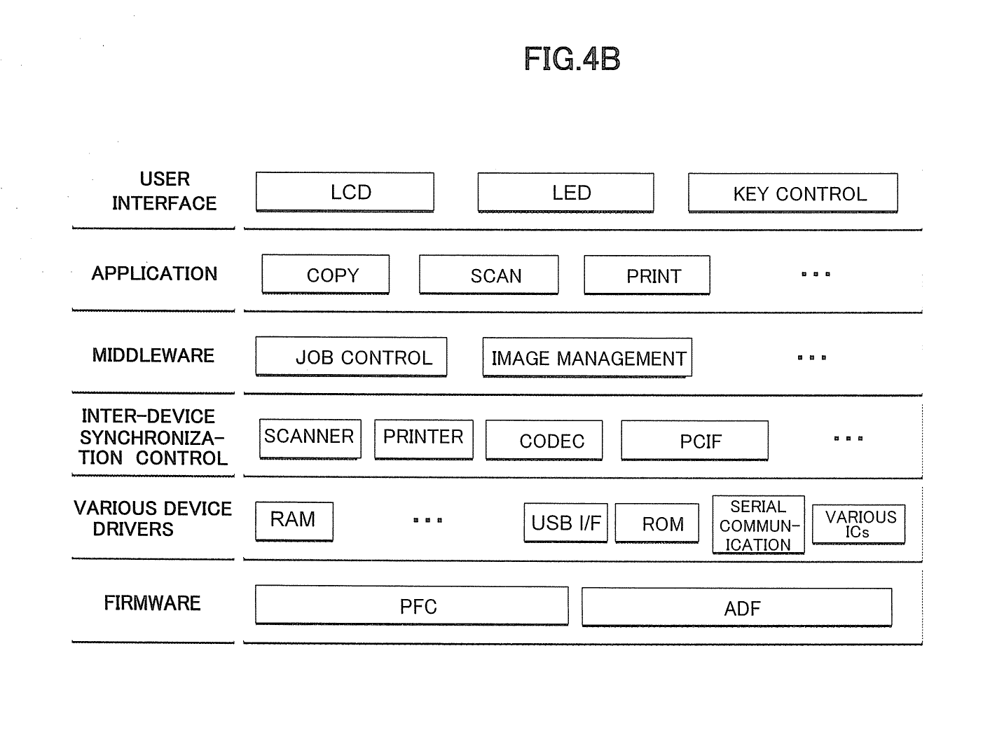

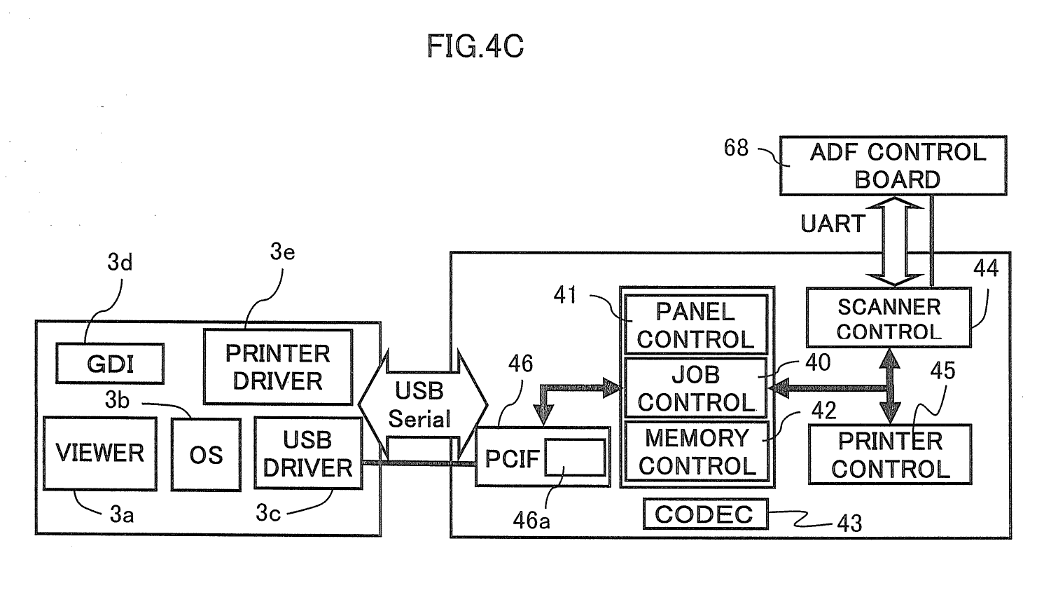

A hardware structure and a software structure concerning the controller 39 will be described with reference to FIGS. 3, 4A, 4B and 4C.

FIG. 3 is a view showing a part of the hardware structure in which the control of the MFP 1 is main. The same reference numerals as the previously mentioned ones denote the same components.

The controller 39 includes a CPU (central processing unit) 60, a ROM (read only memory) 61, a RAM (random access memory) 62 and a bus 63 on a control board 75.

The CPU 60 executes a program. The program includes a device driver, an inter-device control software, a middleware, and an application (application software).

The ROM 61 is an FROM to store an OS (operating system) and various programs.

The RAM 62 creates a print queue of print data. The RAM 62 includes an SDRAM (synchronous dynamic random access memory) having a volatile work area and an SRAM (static random access memory) having a nonvolatile storage area.

The controller 39 includes the bus 63 and a DMA (direct memory access) controller 64. The bus 63 is a system bus. The DMA controller 64 DMA transfers data on the bus 63.

The controller 39 includes a panel LSI 65 and a panel interface 66. The panel LSI 65 is for display driving of, for example, the display 37. The panel interface 66 interfaces the panel board 38 with the panel LSI 65.

The controller 39 controls an ADF control board 68 through an ADF interface 67. The ADF control board 68 controls the movement amount of the image sensor unit 30.

The controller 39 includes a printer LSI 69. The printer LSI 69 controls the image forming process part 19, the fixing unit 18 and the laser scan unit 23.

The controller 39 includes a billing counter 70 in the image forming process part 19. The counter 70 stores the number of sheets 50 printed and outputted by the image forming process part 19. The counter 70 is a hardware register.

The controller 39 includes a scanner LSI 71. The scanner LSI 71 functions as the image processing part 31.

The controller 39 includes a communication control LSI 72. The communication control LSI 72 analyzes a received AT command, and determines an AT command to be transmitted.

The controller 39 includes a USB interface 73 (transmission and reception part). The USB interface 73 transmits and receives a command signal through USB communication protocol. The controller 39 monitors a USB plug 74 by the USB interface 73.

In the MFP 1, the CPU 60, LSI, interface IC and the like are substantially concentrated on one portion of the control board 75.

FIGS. 4A to 4C show an example of the software structure of the MFP 1.

FIG. 4A is a diagram showing a control portion of plural software modules. FIG. 4B is a view showing an example of a layer structure of the software module. FIG. 4C is a view showing an example of relation among the software modules. In FIGS. 4A to 4C, the same reference numerals as the previously mentioned ones denote the same components.

The layer is a layer classified to execute a function of one control portion. In the MFP 1, the software module is divided into units for respective layers and is operated.

As shown in FIG. 4A, the MFP 1 executes, as control items, system, job control (job management), panel control, memory control, codec, scanner control, printer control, and personal computer interface (PCIF) control.

The system is a software module for controlling the ROM 61, the RAM 62 and various LSIs.

A job control module 40 is a software module for job management, process control, mail control and sequence control.

The job is a unit of process viewed from the user. The process is a unit of program execution for the job.

The mail is message communication between plural generated processes. The sequence is contents of a process previously defined by plural states and plural events.

A panel control module 41 is a software module for controlling the operation panel 34.

A memory control module 42 is a software module for reading/writing data stored in the RAM 62.

A codec module 43 is a software module for compression and expansion.

A scanner control module 44 is a software module for controlling the scanner unit 32.

A printer control module 45 is a software module for controlling the image forming process part 19 and the conveyance mechanism 14.

A personal computer interface module 46 is a software module for communication with the personal computer 2.

Various device drivers of a software layer are a processing system for directly controlling registers in order to sufficiently utilize the hardware.

The CPU 60 installs device drivers in the OS. The OS operates peripheral equipments through the device drivers.

The MFP 1 stores the device driver for each of the RAM 62, the ROM 61, the USB interface 73, and various ICs (integrated circuit). The IC is a general-purpose LSI or ASIC (application specific integrated circuit).

The inter-device synchronization control is a processing system which functions when synchronization with a peripheral module is performed in a process in which the CPU 60 processes a device driver.

The middleware is a function and a processing system to perform an adjustment viewed from the whole system and an intermediate process for another module.

The application is a function and a processing system capable of directly giving a benefit in visible form to the user.

In FIG. 4B, a serial communication is a serial communication by UART (universal asynchronous receiver/transmitter) between the scanner control module 44 and the ADF control board 68. A serial communication function module is in the scanner LSI 71.

A firmware is for control of the cassette parts 11 and 12 and the automatic document feeder 29.

The personal computer interface module 46 will be described in detail.

In the personal computer interface module 46, a software module belonging to the layer of the application has a function of USB communication.

A software module belonging to the layer of the middleware encodes data and decodes data.

The personal computer interface module 46 uses a coding/decoding scheme suitable for data in which the bit length is long and the bit length is variable. The personal computer interface module 46 uses a scheme including three fields of data identifier, data length and data content.

The personal computer interface module 46 uses, for example, ITU-T (international telecommunication union telecommunication standardization sector) recommendation T.32 or ASN.1 including old CCITT (consultative committee on international telegraphy and telephony) X.409.

A software module belonging to the layer of the inter-device synchronization control has a function of mail control and sequence control.

A software module belonging to the layer of the device driver has a function of USB interface control.

In this embodiment, in the MFP 1, software modules surrounded by circular frames in FIG. 4A have a function to insert a parameter and to read a parameter. The parameter identifies the possibility or impossibility of manual two-sided printing, start of manual two-sided printing, a paper feed source, a paper discharge destination, the print number of copies, a paper type and the like.

The MFP 1 controls the sequence of the manual two-sided printing by the parameter. The control of the sequence is to execute the sequence by transmitting and receiving a message between software modules.

The MFP 1 is instructed by the personal computer 2 to perform the manual two-sided printing of a document by the parameter. The memory control module 42, the codec module 43, the scanner control module 44, the printer control module 45 and the personal computer interface module 46 share the parameter among the modules, and control the sequence.

In the sequence, the MFP 1 prints all even pages, and detects that a sheet bundle is set on the manual paper feed tray 4, and after the MFP 1 communicates with the personal computer 2, the MFP 1 prints all odd pages.

In the two-sided printing method of the embodiment, first, the personal computer 2 sends print data of even pages of all pages to the MFP 1, and the MFP 1 prints all the even pages on one side of the sheets 50.

The user reverses the plural printed and outputted sheets 50, and sets the sheets 50 on the manual paper feed tray 4. The sensor 13b sends the existence of the sheet bundle to the controller 39. The controller 39 notifies the personal computer 2 of the resumption.

The personal computer 2 sends print data of odd pages to the controller 39. The controller 39 prints all the odd pages on the other side of the sheets 50.

The personal computer interface module 46 controls the sequence between the personal computer 2 and the image forming process part 19.

In the embodiment, the personal computer 2 switches the even page printing and the odd page printing by a command sent to the personal computer interface module 46.

The personal computer 2 inserts a parameter into the command.

In the manual two-sided printing, the personal computer 2 always selects the paper discharge tray 20 as the paper discharge destination. The selection is fixed in order to facilitate the user to take out the printed result and to reverse it.

When receiving the command to instruct the manual two-sided printing, the MFP 1 prints and outputs all print data of even pages. After completion of the printing, the MFP 1 pulls the sheets 50 from the manual paper feed tray 4. In the MFP 1, the plural sheets 50 on one side of each of which the even page is printed are manually set on the manual paper feed tray 4.

The print data of odd pages is printed on the plural sheets 50 on the manual paper feed tray 4.

The personal computer 2 sends only the print data of even pages of a document to the personal computer interface module 46. After print completion of the even pages is notified from the personal computer interface module 46, the personal computer 2 sends only the print data of odd pages to the personal computer interface module 46.

The personal computer interface module 46 receives a command including a parameter. The personal computer interface module 46 calls the printer control module 45. The printer control module 45 causes the image forming process part 19 to run.

The image forming process part 19 pulls the sheets 50 from the cassette part 11, prints only the even pages on one side of the sheets 50, and outputs the sheets 50 to the paper discharge tray 20.

The user reverses all the sheets 50. The user sets the sheets 50 on the manual paper feed tray 4.

The personal computer interface module 46 calls the printer control module 45. The printer control module 45 causes the image forming process part 19 to run.

The image forming process part 19 pulls the sheets 50 from the manual paper feed tray 4, prints only the odd pages on the other side of the sheets 50, and outputs the sheets 50 to the paper discharge tray 20.

An example of printing on the sheets 51 is the same as the example of the sheets 50.

A structural example of the personal computer 2 will be described.

As shown in FIG. 4C, the software module of the personal computer 2 includes a viewer 3a, an OS 3b, a USB driver part 3c, a graphic device interface 3d, and a printer driver 3e.

The viewer 3a is an application on the OS 3b. The viewer 3a displays a menu screen for dialog. Information is set in the viewer 3a by user setting.

The viewer 3a sends a sheet size for identifying a paper feed source to the OS 3b. The viewer 3a sends a print type to the OS 3b. The print type designates normal one-sided printing or manual two-sided printing. The viewer 3a sends the print number of copies and a paper type to the OS 3b.

The USB driver part 3c creates a command signal including the sheet size, the print type and the print number of copies as parameters and sends the command signal to the MFP 1.

The USB driver 3c functions also as an end point. The endpoint is an end of a logical communication channel between the MFP 1 and the personal computer 2.

The graphic device interface 3d communicates data between, for example, a document creating application and the MFP 1. The graphic device interface 3d converts a document into, for example, a bitmap.

The printer driver 3e creates print data. The printer driver 3e receives image data from the graphic device interface 3d. The printer driver 3e converts the image data into the print data which can be interpreted by the MFP 1.

The communication between the MFP 1 and the personal computer 2 will be described.

The USB plug 74 of the MFP 1 includes four wires. The two wires are lines for a power source and the ground. The other two wires are lines for signals (D+, D−).

The USB interface 73 receives the D+ signal and the D− signal from the personal computer 2.

The USB interface 73 incorporates respective functions of USB device control, buffering, timer and the like. The USB interface 73 actuates USB device controller so that the buffer functions as an end point.

The personal computer interface module 46 causes the application “USB communication” of FIG. 4A to run.

The USB interface 73 provides the application “USB communication” with the logical communication channel between the MFP 1 and the personal computer 2.

The plug and play function of the MFP 1 will be described.

The controller 39 detects that the personal computer 2 is connected to the USB plug 74. The controller 39 sends an query to the personal computer 2.

The controller 39 receives device identification information from the personal computer 2 and first recognizes the connection with the personal computer 2.

The controller 39 loads a device driver to the OS. The OS allocates an intrinsic address to the personal computer 2 on the bus 63.

The controller 39 schedules data transfer between the MFP 1 and the personal computer 2. The controller 39 transfers the data to the end point of the personal computer 2.

The user pulls out the USB cable 3 or the personal computer 2 from the USB plug 74. The controller 39 detects that the USB cable 3 is disconnected. The OS releases the address allocation to the personal computer 2. The OS unloads the device driver.

The operation of the MFP 1 of the embodiment having the foregoing structure will be described.

FIG. 5 is a view showing a mutual relation among the viewer 3a, the personal computer interface module 46, a communication module 46a, the memory control module 42 and the printer control module 45. The drawing shows cooperation among processes and programs executed as tasks created by the processes.

As indicated by (A), the personal computer interface module 46 includes the communication module 46a to receive, to create and to transmit an AT command signal.

The personal computer interface module 46 receives a command and a parameter attached to the command from the viewer 3a. The personal computer interface module 46 receives the paper feed source, the print number of copies and the paper type.

The personal computer interface module 46 detects that blank data starts to be transmitted. The personal computer interface module 46 initializes the flag and sets a value in the flag before receiving the blank data.

As indicated by (B), the personal computer interface module 46 creates a parameter and sends a command to the viewer 3a.

When an error occurs during printing of an odd page, the personal computer interface module 46 creates the parameter.

As indicated by (C), the personal computer interface module 46 starts plural tasks, and creates mail information among the software modules. The personal computer interface module 46 executes an inner process. The inner process is the setting process of the paper feed source and the paper discharge destination indicated by the parameter in the received command.

As indicated by (D), the personal computer interface module 46 notifies the printer control module 45 of the detection of the blank data and the print type.

As indicated by (E), the personal computer interface module 46 notifies the memory control module 44 of the paper feed source, the paper discharge destination and the print type.

As indicated by (F), the printer control module 45 starts a task, and creates mail information among the software modules. When the blank data is received, the printer control module 45 stops the billing counter 70 and the total counter.

As indicated by (G), the memory control module 44 creates page information for the received print data, and notifies the printer control module 45 of the page information. The memory control module 44 sets the paper feed source and the paper discharge destination notified from the viewer 3a into the page information.

### (1-1) Basic Sequence

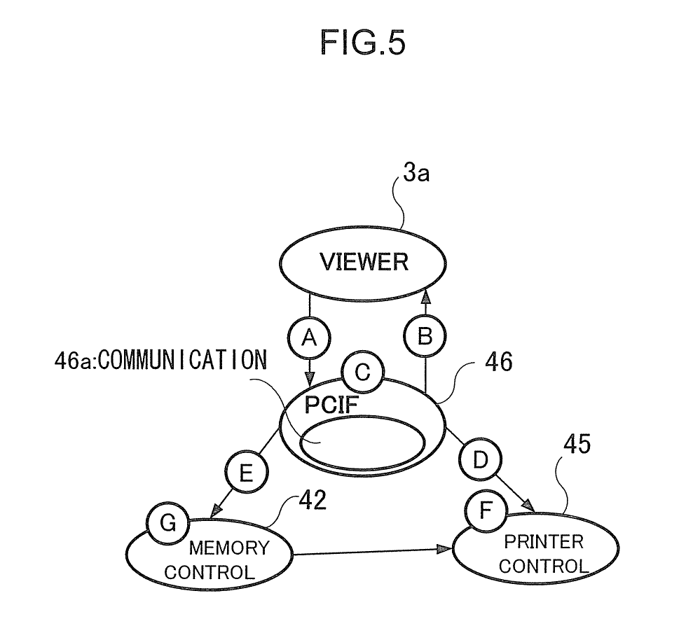

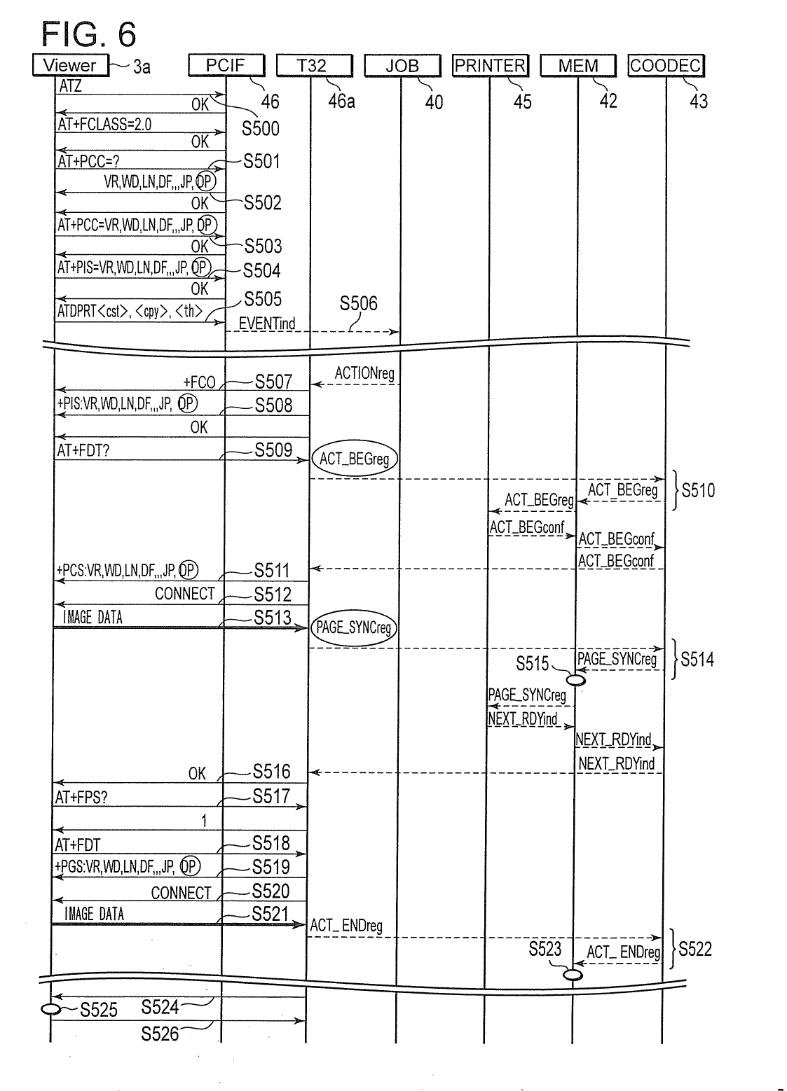

FIG. 6 is a view showing the basic sequence of the manual two-sided printing method. For example, the MFP 1 prints a document of four pages. T32 represents the communication module 46a to transmit and receive an AT command.

At Act S500, the viewer 3a sends a job start to the personal computer interface module 46.

At Act S501, the viewer 3a inquires of the personal computer interface module 46 about the possibility or impossibility of two-sided printing.

At Act S502, the personal computer interface module 46 inquires of the viewer 3a about information such as VR (vertical resolution), WD (page width), LN (page length), DF (data compression) and the presence or absence (JP) of support of JPEG.

The personal computer interface module 46 adds the parameter DP to the command and sends it to the viewer 3a. The parameter indicates that the two-sided printing is possible.

At Act S503 and Act S504, the viewer 3a sends information to the inquiry before transferring the print data to the personal computer interface module 46. The personal computer interface module 46 sends back the page width, the page length, the data compression and the like of the first even page.

At Act S505, the viewer 3a sends a print start. The viewer 3a inserts the parameters, such as the paper feed source, the print number of copies and the paper type, into the command.

At Act S506, the personal computer interface module 46 notifies the job control module 40 of the occurrence of an event.

The information necessary for printing is collected in the MFP 1. After this, the communication module 46a takes over transmission and reception of print data to and from the viewer 3a.

At Act S507 and S508, the communication module 46a sends preparation OK and print capacity to the viewer 3a. The command includes the parameter indicating that the manual two-sided printing is OK.

At Act S509, the viewer 3a transmits the setting completion and execution start to the communication module 46a.

At Act S510, the communication module 46a creates a message, and causes the memory control module 42 to set the paper feed source of the page to be printed and the paper discharge destination (paper discharge tray 20).

The memory control module 42 sets the paper feed source and the paper discharge destination into the page information. The printer control module 45 notifies the memory control module 42 of the remaining amount of the cassette parts 11 and 12.

At Act S511, the communication module 46a transmits actual print capacity to the viewer 3a. The command includes the parameter indicating that the manual two-sided printing is OK.

At Act S512, the communication module 46a transmits connection start to the viewer 3a.

At Act S513, the viewer 3a sends print data of the first even page to the communication module 46a.

At Act S514, the communication module 46a creates a reception message, and causes the memory control module 42 to set the paper feed source and the paper discharge destination of the print data.

At Act S515, the memory control module 42 registers the first even page into a print queue.

At Act S516, the communication module 46a sends OK to the viewer 3a.

At Act S517, the viewer 3a sends a print result request to the communication module 46a.

At Act S518, the viewer 3a transmits setting completion and execution start to the communication module 46a.

At Act S519, the communication module 46a transmits actual print capacity to the viewer 3a. The command includes a parameter indicating that the manual two-sided printing is OK.

At Act S520, the communication module 46a transmits the connection start to the viewer 3a.

At Act S521, the viewer 3a sends print data of the second even page to the communication module 46a.

At Act S522 and Act S523, the memory control module 42 registers the second even page into the print queue.

Thereafter, the image forming process part 19 prints and outputs all even pages.

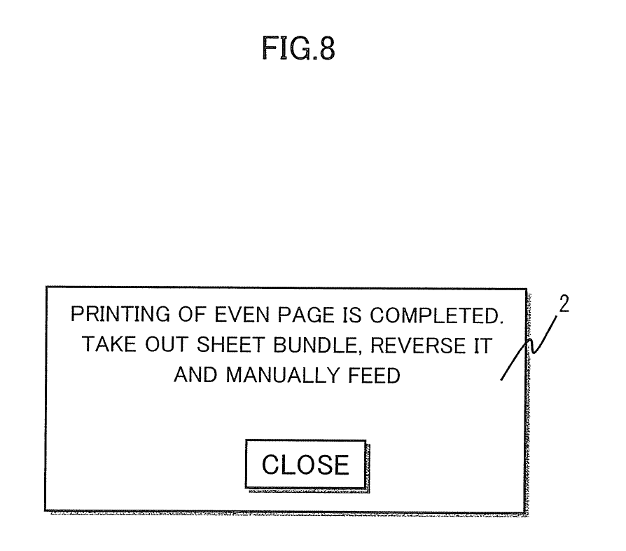

When the printing is completed, the personal computer 2 displays, for example, a screen as shown in FIG. 8. The screen urges the user to reverse the printed sheets 50 and to set them on the manual paper feed tray 4.

The user sets the sheets 50 on the manual paper feed tray 4 in accordance with the screen. The controller 39 detects the setting.

At Act S524, the communication module 46a transmits the information (size etc.) of the cassette managed by the printer control module 45 to the viewer 3a of the personal computer 2.

At Act S525, the personal computer 2 determines whether the notified sheet size is equal to the sheet size when the even pages are printed. When the sizes are equal to each other, the personal computer 2 determines that printing of the odd pages can be started.

At Act S526, the viewer 3a sends print data of the first odd page to the communication module 46a. The printing is started by a PC trigger.

With respect to the second odd page, the MFP 1 sends print data similarly to the example of the first odd page. The printer control module 45 registers the print data of all the odd pages into the print queue.

Thereafter, the image forming process part 19 pulls two sheets from the manual paper feed tray 4. The image forming process part 19 prints two odd pages on the other side of the respective sheets 50 on one side of which the two even pages were respectively printed.

### (1-2) Specific Example of the Sequence

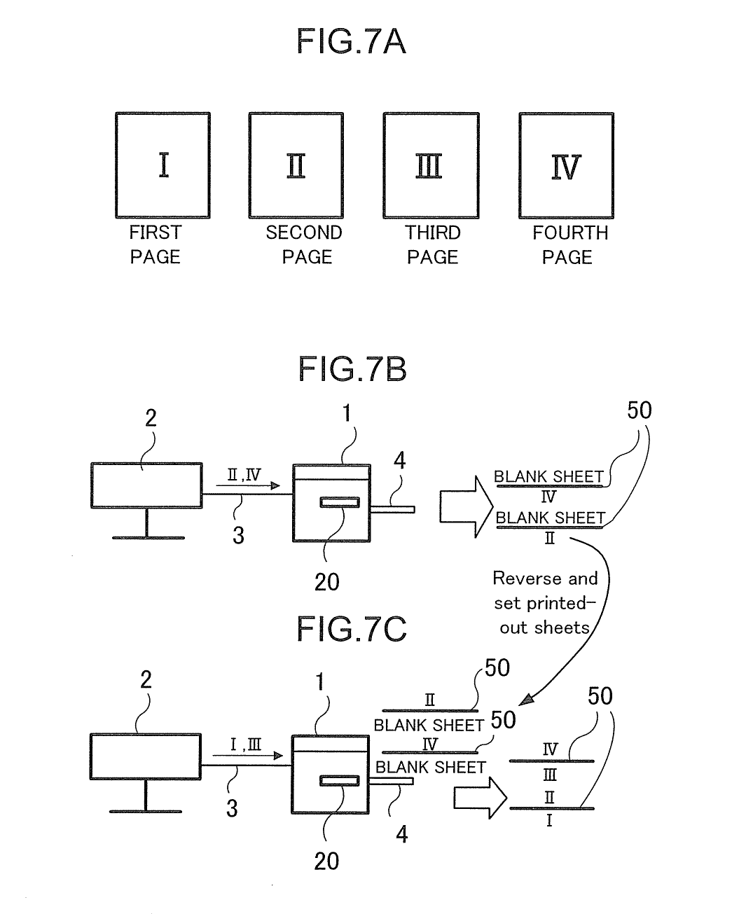

FIG. 7A is a view showing an image of print data. In the drawing, the same reference numerals as the already mentioned ones denote the same components. It is assumed that the sizes of print data I, II, III and IV are the same size among the first page, the second page, the third page and the fourth page.

The cassette part 11 contains the sheets 50 of ISO (international standard) A4 size. The cassette part 12 contains the sheets 51 of ISO A3 size.

FIG. 7B is a view for explaining a first procedure. An example of a user request is that the first page to the fourth page are printed on the sheets 50 of A4 size. The personal computer 2 sends the print data II and IV of the even pages to the MFP 1 in order of II and IV.

The MFP 1 pulls the sheets 50 one by one from the cassette part 11. The MFP 1 prints the sent print data II and IV on one side of the two sheets 50. The MFP 1 outputs the two sheets 50 onto the paper discharge tray 20.

The MFP 1 discharges the sheets 50 on the lower surfaces of which the print data II and IV are respectively printed.

FIG. 8 is a view showing an example of the display's indication of the personal computer 2. The personal computer 2 displays the print completion of the even pages on the display. The personal computer 2 urges the user to reverse the sheets 50.

The user standing near the MFP 1 pulls out the manual paper feed tray 4. The user reverses the two sheets 50. The user piles the two sheets 50 and set them on the manual paper feed tray 4.

The MFP 1 detects that the sheets 50 are set on the manual paper feed tray 4.

FIG. 7C is a view for explaining a second procedure. The personal computer 2 sends the print data I and III of the odd pages to the MFP 1 in order of I and III.

The MFP 1 pulls the sheets 50 one by one from the manual paper feed tray 4. The MFP 1 prints the sent print data I and III on one side of the sheets. The MFP outputs the two sheets 50 onto the paper discharge tray 20.

The MFP 1 prints the print data I on the other side of the sheet 50 on one side of which the print data II was printed. The MFP 1 prints the print data III on the other side of the sheet 50 on one side of which the print data IV was printed.

The MFP 1 discharges the two sheets 50. As a result, the two-sided printing is realized in order of I, II, III and IV.

Besides, when the sheet size of the sheet 50 when the even page is printed is not equal to the sheet size of the manual paper feed tray 4, the MFP 1 transmits the actual printing capacity to the personal computer 2. The parameter of the command indicates the inconsistency of the sheet size.

The personal computer 2 extracts the parameter from the command. The personal computer 2 displays a screen to urge setting of correct sheet size on the display.

The personal computer 2 waits for user input. The personal computer 2 determines whether the input value is the correct sheet size. When the personal computer 2 confirms that the input value is the correct value, the personal computer 2 sends back the command to the MFP 1. The MFP 1 resumes printing.

The above is the example when the number of the odd pages is equal to the number of the even pages.

### (2-1) Example when the Number of Odd Pages is Different from the Number of Even Pages

A description will be made on an example where the number of odd pages is larger than the number of even pages by one, for example, an example of a first page, a second page and a third page.

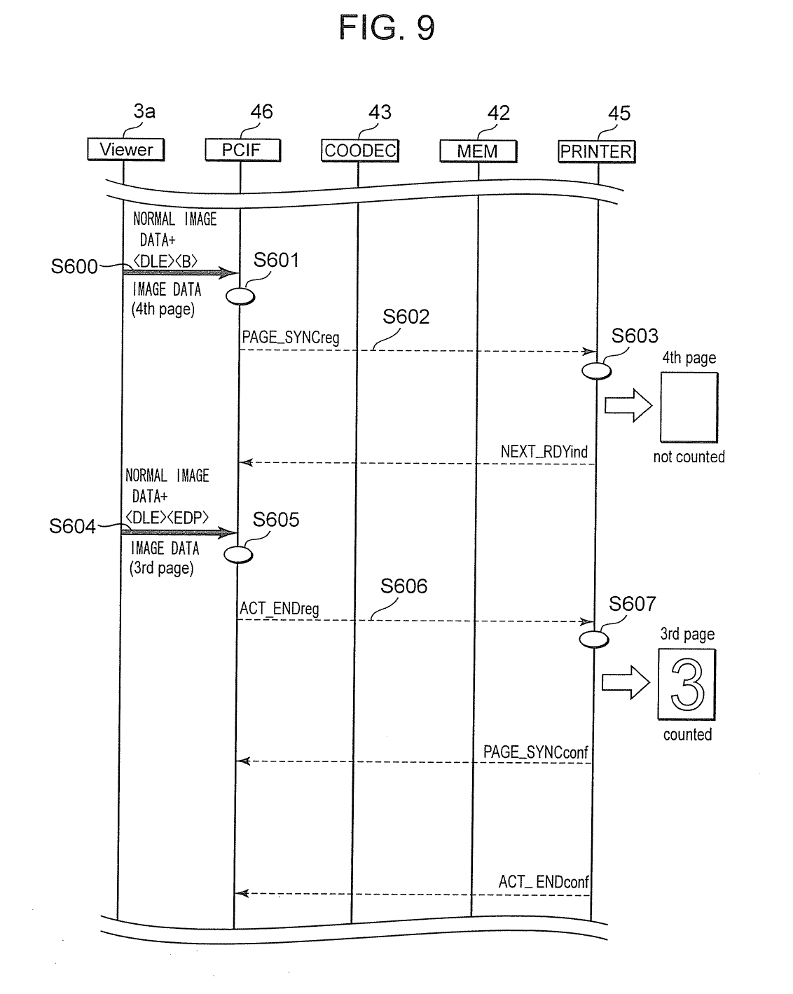

FIG. 9 is a view showing a print sequence of the manual two-sided printing method in which blank data is added. The blank data is data for a blank page. The same reference numerals as the already mentioned ones denote the same components.

The process by the MFP 1 is the process in which the sequence of FIG. 9 is substantially added to the sequence of FIG. 7. That is, in FIG. 7B, the personal computer 2 sends the blank data as the print data IV of the fourth page of the document to the MFP 1.

At Act S600, the blank data is sent to the personal computer interface module 46. The viewer 3a embeds information indicating the blank data into the blank data.

At Act S601, the personal computer interface module 46 detects the reception of the blank data. The personal computer interface module 46 completes the reception of the blank data.

The personal computer interface module 46 starts to create a command. The command causes the printer control module 45 to recognize printing of the blank data.

The personal computer interface module 46 secures a flag area in the RAM 62. The flag is information indicating that the blank data is detected. The personal computer interface module 46 turns on the flag.

At Act S602, the personal computer interface module 46 inserts the flag into the message, and notifies the printer control module 45 of the message.

At Act S603, the printer control module 45 receives the notification of the blank data from the personal computer interface module 46. The function of the notification is executed by a function provided by the personal computer interface module 46.

When the flag of the message is on, the printer control module 45 changes the operation of the image forming process part 19 to the print operation for blank data. The printer control module 45 registers the blank data into the print queue.

The image forming process part 19 prints the fourth page on the back surface of the sheet 50. The counter 70 does not count the fourth page.

At subsequent Act S604, the viewer 3a sends normal data to the personal computer interface module 46. The viewer 3a embeds information indicating the normal data into the normal data.

The viewer 3a sends the print data III of the third page to the personal computer interface module 46.

At Act S605, the personal computer interface module 46 detects the reception of the normal print data. The personal computer interface module 46 receives the print data III.

At Act S606, the personal computer interface module 46 turns off the flag. The personal computer interface module 46 inserts the off flag into the message, and notifies the printer control module 45 of the thus obtained message.

At Act S607, the printer control module 45 receives the notification of the message from the personal computer interface module 46 by a function.

When the flag of the message is off, the printer control module 45 does not change the operation of the image forming process part 19 to the printing operation for blank data. The printer control module 45 registers the normal print data III in the print queue.

The image forming process part 19 prints the third page on the front surface of the sheet 50. The counter 70 counts the third page.

The counter 70 continues to count the number of the printed and outputted sheets 50.

The counter 70 does not count the printing of the final fourth page on the back surface of the sheet 50. Although the blank data is received, the MFP 1 does not charge for the blank data.

The counter 70 counts the printing of the final fourth page on the front surface of the sheet 50. The MFP 1 charges for the third pages.

Since the blank data is not the data intended by the user, charging is not made.

Besides, when a jam occurs in a period in which the MFP 1 is printing the odd page from the manual paper feed tray 20, the MFP 1 holds the printing.

When the personal computer 2 is instructed to resume by the user input, the personal computer 2 notifies the MFP 1 of the resumption. On the other hand, after removing the jam, the MFP 1 resumes the printing from the first page. Even if the printing is resumed from halfway, the page is not shifted.

### (2-2) Specific Example

A description will be made on a method of performing manual two-sided printing on a document in which the number of pages is odd.

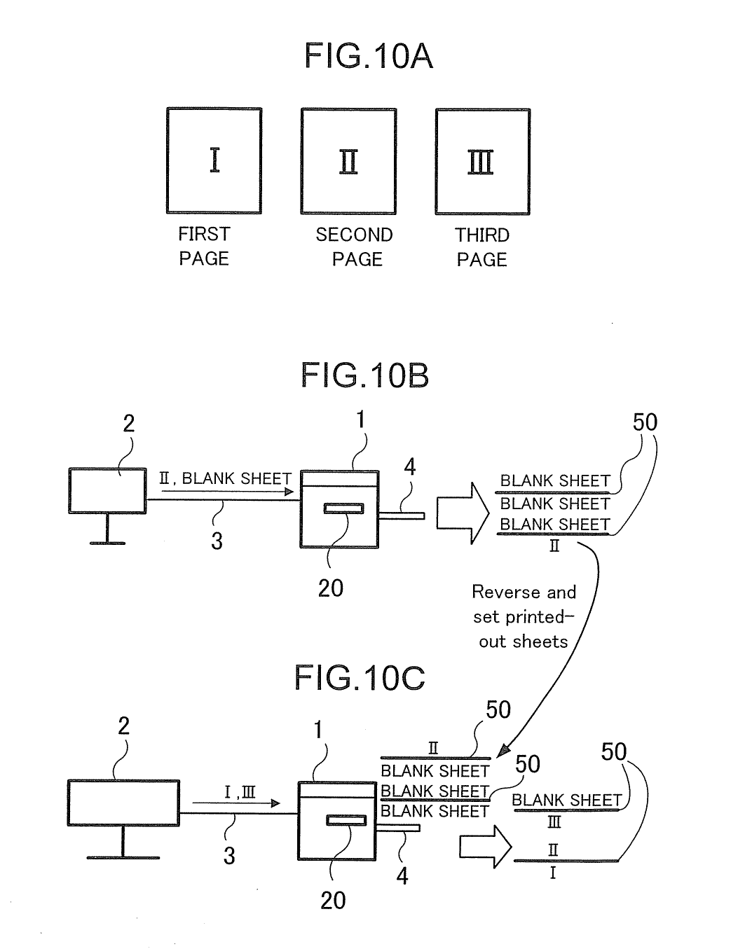

FIG. 10A is a view showing an image of print data. In the drawing, the same reference numerals as the already mentioned ones denote the same components. It is assumed that the sizes of print data I, II, III are the same among a first page, a second page and a third page.

The cassette part 11 is for A4 size, and the cassette part 12 is for A3 size.

FIG. 10B is a view for explaining a first procedure. The user request is such that the first page to the third page are printed on the sheets 50 of A4 size. The personal computer 2 sends the print data II of the even page and blank data to the MFP 1 in order of II and blank data.

Since the even page of the final page does not exist, the personal computer sends the blank data instead of the even page.

The MFP 1 pulls the sheets 50 one by one from the cassette part 12. The MFP 1 prints the sent print data II and the blank data on one side of the two sheets 50. The MFP 1 outputs the two sheets 50 onto the paper discharge tray 20.

The MFP 1 discharges the sheets 50 on the lower surfaces of which the print data II and the blank data are respectively printed.

The user pulls out the manual paper feed tray 4. The user reverses the two sheets 50. The user piles the two sheets 50 and sets them on the manual paper feed tray 4.

The MFP 1 detects that the sheets 50 are set on the manual paper feed tray 4. The MFP 1 notifies the personal computer 2 of the resumption.

FIG. 10C is a view for explaining a second procedure. The personal computer 2 sends the print data I and III of the odd pages to the MFP 1 in order of I and III.

The MFP 1 pulls the sheets 50 one by one from the manual paper feed tray 4. The MFP 1 prints the sent print data I and III on one side of the sheets. The MFP 1 outputs the two sheets 50 onto the paper discharge tray 20.

The MFP 1 prints the print data I on the other side of the sheet 50 on the one side of which the print data II was printed. The MFP 1 prints the print data III on the other side of the sheet 50 on the one side of which the blank data was printed. The MFP 1 discharges the two sheets 50.

As a result, the two-sided printing is realized in order of I, II and III.

Since the blank data is not data intended by the user, identifiable information is sent from the personal computer 2 to the MFP 1 so that billing or counting is not performed.

In the above example, the page size is the same among all the pages.

### (3) Example of a Sequence in which Sheets Having Difference Page Sizes are Mixed

A page size is not the same among all pages. A description will be made on a method of performing manual two-sided printing of a document of plural pages having different page sizes.

The MFP 1 repeats printing of even pages and printing of odd pages for each page size.

The cassette part 11 is for A4 size, and the cassette part 12 is for A3 size.

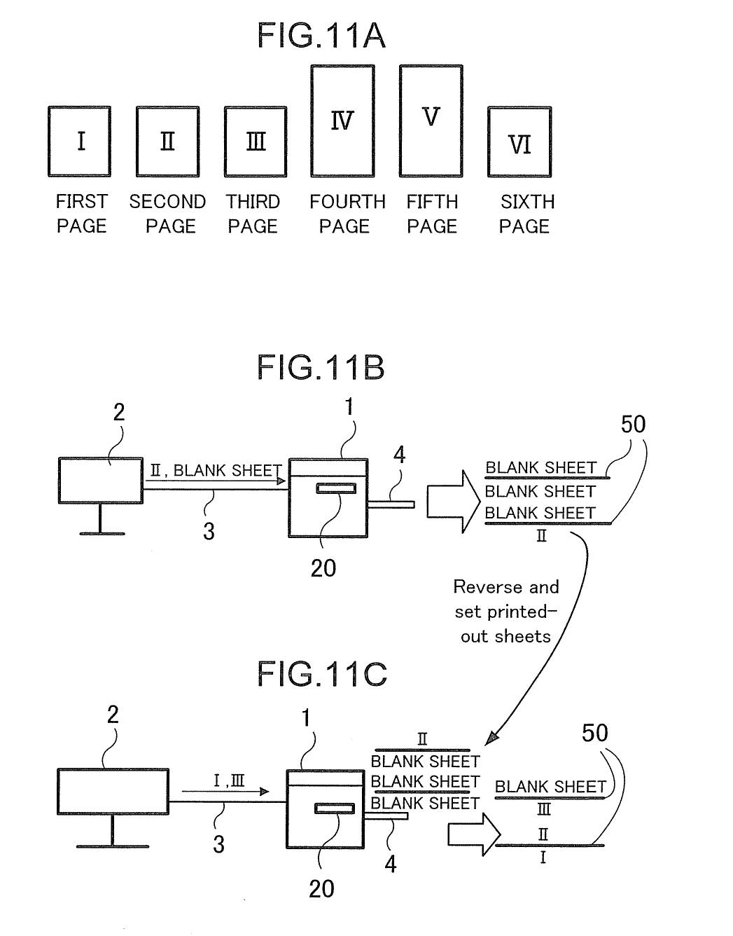

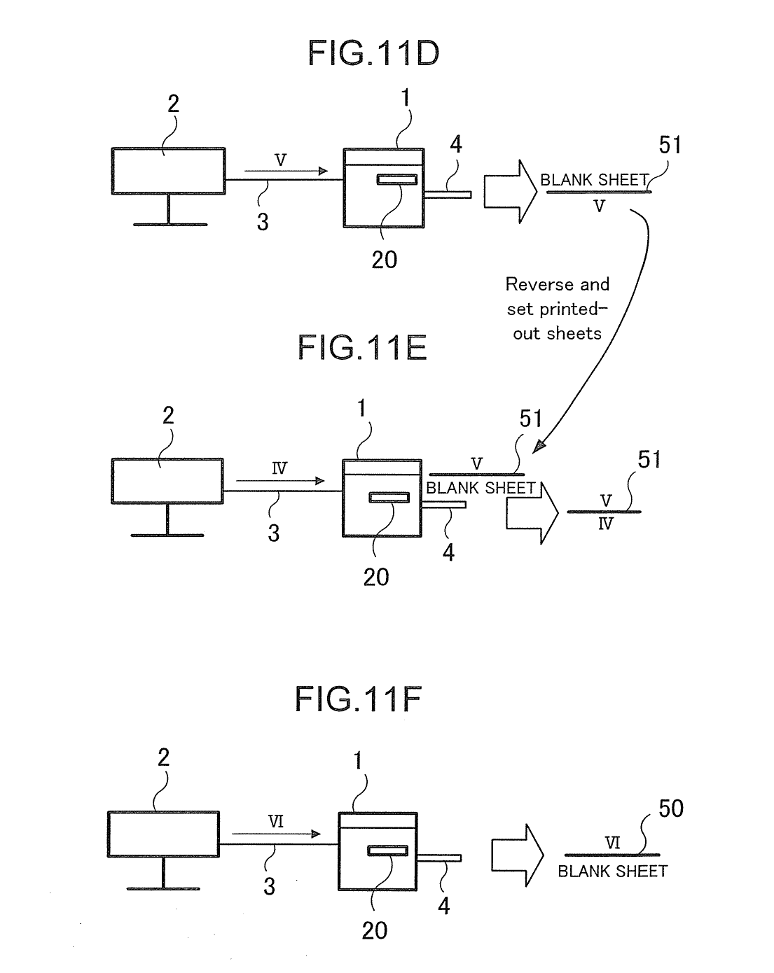

FIG. 11A is a view showing images of print data. It is assumed that the page sizes of print data I, II, III, IV, V and VI are not equal among the first page to the sixth page.

FIG. 11B is a view for explaining a first procedure. In the drawing, the same reference numerals as the already mentioned ones denote the same components.

The user request is such that the first page to the sixth page are printed on A4 size sheets 50. The personal computer 2 sends the print data II of the even page and blank data to the MFP 1 in order of II and blank data.

When the print data of the same size continues, the personal computer 2 sends the print data of the even page. Since the final even page does not exist, the personal computer 2 sends the blank data to the MFP 1.

The MFP 1 pulls the sheets 50 one by one from the cassette part 12. The MFP 1 prints the sent print data II and the blank data on one side of the two sheets 50. The MFP 1 outputs the two sheets 50 onto the paper discharge tray 20.

The MFP 1 discharges the sheets 50 on the lower surfaces of which the print data II and the blank data are printed.

The user pulls out the manual paper feed tray 4. The user reverses the two sheets 50. The user piles the two sheets 50 and sets them on the manual paper feed tray 4.

The MFP 1 detects that the sheets 50 are set on the manual paper feed tray 4. The MFP 1 notifies the personal computer 2 of the resumption.

FIG. 11C is a view for explaining a second procedure. In the drawing, the same reference numerals as the already mentioned ones denote the same components. The personal computer 2 sends the print data I and III to the MFP 1 in order of I and III.

The MFP 1 pulls the sheets 50 one by one from the manual paper feed tray 4. The MFP 1 performs one-sided printing of the sent print data I and III. The MFP 1 outputs the two sheets 50 onto the paper discharge tray 20.

The MFP 1 prints the print data I on the other side of the sheet 50 on the one side of which the print data II was printed. The MFP 1 prints the print data III on the other side of the sheet 50 on the one side of which the blank data was printed. The MFP 1 discharges the two sheets 50.

FIG. 11D is a view for explaining a third procedure. In the drawing, the same reference numerals as the already mentioned ones denote the same components.

After the printing of the odd pages is completed, the personal computer 2 reads the print data IV and the print data V, both of which have A3 size different from A4 size. The personal computer 2 sends the print data V of the even page to the MFP 1.

The MFP 1 performs one-sided printing of the print data V. The MFP 1 outputs the one sheet 51 onto the paper discharge tray 20. The size of the sheet 51 is different from the size of the sheet 50.

The user pulls out the manual paper feed tray 4. The user reverses the one sheet 51. The user sets the one sheet 51 on the manual paper feed tray 4.

FIG. 11E is a view for explaining a fourth procedure. In the drawing, the same reference numerals as the already mentioned ones denote the same components.

The MFP 1 detects that the sheet 51 is set on the manual paper feed tray 4. The MFP 1 notifies the personal computer 2 of the resumption.

The personal computer 2 sends the print data IV of the odd page to the MFP 1. The MFP 1 performs one-sided printing of the print data IV. The MFP 1 prints the print data IV on the other side of the sheet 51 on the one side of which the print data V is printed.

FIG. 11F is a view for explaining a fifth procedure. In the drawing, the same reference numerals as the already mentioned ones denote the same components.

After the printing of the A3 size sheet 51 is completed, the personal computer 2 reads the A4 size print data VI and sends the print data VI to the MFP 1. The MFP 1 prints the print data VI on one side of the sheet 50.

As a result, the two-sided printing is realized in order of I, II, III, IV, V and VI. Even when the page sizes are different, the manual two-sided printing becomes possible.

According to the two-sided printing method, it is unnecessary for the user to repeat the procedure of printing sheets one by one.

### (4) Other Embodiments

The MFP 1 may change the printing order of even pages and odd pages. The MFP 1 first prints the odd pages on one side of the sheets 50 and outputs them. The user reverses the sheets 50 and sets them to the MFP 1. The MFP 1 prints the even pages on the other side of the sheets 50 and outputs them;

Although the MFP 1 receives the blank data from the personal computer 2 and prints the blank data, the MFP 1 receives a command indicating blank data, pulls the sheet 50 from the cassette part 11, and may output the sheet to the paper discharge tray 20 without printing.

After the MFP 1 copies both sides of a document having plural pages by using the image sensor unit 30 and the scanner unit 32, the copy data may be subjected to the manual two-sided printing.

Although the USB plug 74 of the MFP 1 is connected with the personal computer 2, the USB plug 74 may be connected with another USB device.

The another USB device is a USB flash memory, a hard disk drive having a USB interface, a digital camera having a USB interface or the like.

The MFP 1 may be connected with a finishing apparatus. Parameters from the personal computer 2 to the MFP 1 include the presence or absence of sorting, and the position of a staple.

Although the MFP 1 uses the wired USB cable 3, the MFP 1 may include a wireless section in a transmission section to which the USB protocol is applied.

Although the MFP 1 includes the one USB plug 74, the MFP may include plural USB plugs 74.

Although the image forming process part 19 is for a monochrome image, the image forming process part may be for a color image.

In the embodiment, although the image forming apparatus is the MFP 1, the image forming apparatus may be a facsimile apparatus including the USB plug 74, a printer, or a copying machine.

The content of FIG. 5 is an example and can be variously modified.

The structure of the software module and the hardware of the MFP 1 can be variously modified. The superiority of the invention is not impaired as compared with the invention in which the structure of the software module and the hardware of the personal computer 2 are modified and carried out.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the spirit of the inventions. The accompanying claims and their equivalents are intended to cover such forms or modifications as would fall within the scope and spirits of the inventions.

What is claimed is:

1. An image forming apparatus comprising:
a transmission and reception part configured to transmit and receive a command signal to and from a computer apparatus through a USB (universal serial bus) communication interface and receive print data of each of a plurality of pages page by page;
a cassette part configured to feed a sheet on which the print data received by the transmission and reception part is to be printed;
a printing part configured to form an image on the sheet and to output the sheet;
a paper discharge part configured to store the sheet printed out by the printing part;
a manual paper feed tray on which the sheet discharged from the paper discharge part is set with the image being printed on a side of the sheet and an opposite side of the sheet being to be printed; and
a control part configured to cause the printing part to print an even page on one side of a sheet from the cassette part and print an odd page on the other side of the same sheet from the manual paper feed tray.

2. The apparatus of claim 1, wherein the control part causes the printing part to pull the sheet from the cassette, to output the sheet on the one side of which the even page is printed to the paper discharge part, causes the transmission and reception part to communicate with the computer apparatus, and then causes the printing part to pull the sheet from the manual paper feed tray, and to output the sheet on the other side of which the odd page is printed to the paper discharge part.

3. The apparatus of claim 1, wherein the transmission and reception part receives page information of the even page or the odd page before starting to receive the print data from the computer apparatus.

4. The apparatus of claim 1, wherein the transmission and reception part inserts a parameter indicating at least possibility or impossibility of manual two-sided printing and a paper feed source into the command signal.

5. The apparatus of claim 1, further comprising:
a billing counter configured to count the number of times of printing of the printing part; and
a storage part configured to store a number of a page to be printed with blank data among the print data of the respective pages and a flag corresponding to the number, wherein
the control part counts up the counter each time printing on the sheet by the printing part is completed, and neglects count-up of the counter after printing on the page having the number corresponding to the flag is completed.

6. The apparatus of claim 5, wherein the transmission and reception part receives the command signal including an identifier indicating the blank data, and the control part sets the flag by the identifier.

7. The apparatus of claim 1, further comprising:
a jam sensor configured to detect occurrence and removal of a jam of the sheet, wherein
if the jam sensor detects the removal of the jam and the computer apparatus notifies the transmission and reception part of resumption, the control part causes the printing part to resume printing from the first page.

8. The apparatus of claim 1, wherein the control part determines whether a sheet size of the print data is equal to a sheet size of the manual paper feed tray, and if a determination result is affirmative, the control part causes the printing part to execute printing.

9. The apparatus of claim 1, wherein the control part determines whether a sheet size of the print data is equal to a sheet size of the manual paper feed tray, and if a determination result is negative, the control part causes the transmission and reception part to notify the computer apparatus of information to correct the sheet size of the print data.

10. The apparatus of claim 1, wherein when sheet sizes of the print data are a mixture of a plurality of different sheet sizes, the control part causes the printing part to repeat printing of the even page and printing of the odd page for each of the sheet sizes.

11. A two-sided printing method of an image forming apparatus, comprising:
receiving print data of each page of one of a group of all even pages and a group of all odd pages among a plurality of pages from a computer apparatus through a USB communication interface page by page;
pulling a plurality of sheets from a cassette part and printing the respective even pages or the respective odd pages on one side of the plurality of sheets;
detecting that the plurality of sheets are set on a manual paper feed tray while the other side opposite to the one side is made the side to be printed;
receiving print data of each page of the other of the group of all the even pages and the group of all the odd pages, which is different from the first printed page, from the computer apparatus; and
pulling the plurality of sheets from the manual paper feed tray and printing the respective odd pages or the respective even pages on the other side of the plurality of sheets.

12. The method of claim 11, wherein transmitting print completion to the computer apparatus after all the even pages are printed out, receiving an instruction of printing of all the odd pages from the computer apparatus in response to the print completion, and detecting the plurality of sheets on the manual paper feed tray.

13. The method of claim 11, wherein transmitting print completion to the computer apparatus after all the odd pages are printed out, receiving an instruction of printing of all the even pages from the computer apparatus in response to the print completion, and detecting the plurality of sheets on the manual paper feed tray.

14. The method of claim 11, wherein before starting to receipt the print data from the computer apparatus, the image forming apparatus receives page information of the even page or the odd page.

15. The method of claim 11, wherein
a billing counter is counted up each time printing on each sheet is completed, and
on receiving a number of a page to be printed with blank data among the print data of the respective pages from the computer apparatus, executing printing on the page corresponding to the number having the number is performed, and neglecting count-up of the counter after printing.

16. The method of claim 11, wherein after a jam of the sheet occurs, on receiving notification of resumption from the computer apparatus, printing is resumed from the first page.

17. The method of claim 11, wherein
during an operation of the printing the odd page or the even page, determining whether a sheet size of the print data is equal to a sheet size of the manual paper feed tray, and
if a determination result is affirmative, executing the operation of the printing.

18. The method of claim 11, wherein
during an operation of the printing the odd page or the even page, determining whether a sheet size of the print data is equal to a sheet size of the manual paper feed tray, and
if a determination result is negative, notifying information to correct the sheet size of the print data to the computer apparatus.

19. The method of claim 18, wherein the computer apparatus is made to display a screen to urge setting of the correct sheet size of the print data.

20. The method of claim 11, wherein
if sheet sizes of the print data are a mixture of a plurality of different sheet sizes, printing of the even page and printing of the odd page for each of the sheet sizes are repeated.
